(19) United States
(12) Patent Application Publication
(10) Pub. No.: US 2005/0270387 A1
(43) Pub. Date: Dec. 8, 2005

(54) Photographing system and photographing method

(75) Inventors: Seiichi Watanabe, Kanagawa (JP); Yasunori Tanaka, Kanagawa (JP); Zhijin Ye, Kanagawa (JP)

Correspondence Address: SUGHRUE MION, PLLC, 2100 PENNSYLVANIA AVENUE, N.W., SUITE 800, WASHINGTON, DC, 20037, US

(73) Assignees: FUJI PHOTO FILM CO., LTD.; FUJINON CORPORATION

(21) Appl. No.: 11/136,726

(22) Filed: May 25, 2005

(30) Foreign Application Priority Data
May 25, 2004 (JP) 2004-154482

(51) Int. Cl. H04N 5/262; H04N 5/232; G03B 13/00

(52) U.S. Cl. 348/240.99; 348/345

(57) ABSTRACT

The photographing system and method photograph a predetermined photographing spacetime. The system includes image pickup modules having different focal lengths, each picking up an image in the predetermined photographing spacetime. The method uses the image pickup modules. The image pickup modules are set such that the photographing magnification of the image pickup modules having a longer focal length is higher than the photographing magnification of the image pickup modules having a shorter focal length.

This application claims priority on Japanese patent applications No. 2004-154482 and No. 2005-150837, the entire contents of which are hereby incorporated by reference

### BACKGROUND OF THE INVENTION

The present invention relates to a photographing system and a photographing method with which it is possible to pick up an image of a predetermined photographing target, that is, a subject in a photographing space or a photographing region in a predetermined photographing spacetime in a photographing time while maintaining a constant size of the target regardless of a distance to the photographing target, and it is possible to record an image, in particular, a moving image in the entire space of a predetermined continuous three-dimensional space in the predetermined photographing spacetime at an arbitrary point in time in the predetermined photographing time at high definition and in real time. In particular, the present invention relates to a photographing system and a photographing method that are used at a sports ground, a game hall, a school, a store, a station, an airport, a road, a parking lot, an automobile, a railroad, a ship, an airplane, a construction site, a farm, a river, a,mountain, or the like, and are applied to photographing of a sports event or the like, monitoring or photographing for crime prevention, inspection of an accident, observation or survey of an agricultural product, a natural phenomenon, or a disaster, or the like.

Currently, a camera equipped with a wide-angle lens having a wide field of view is used in in-store monitoring for crime prevention or the like, observation of a productor a disaster, verification of an accident or the like, photographing of a sports event, photographing for television broadcasting, or the like. In particular, a camera using an ultra-wide-angle fish-eye lens has been known conventionally as a camera having an extremely wide field of view.

By using a wide-angle lens or a fish-eye lens in the above-described manner, it becomes possible to photograph photographing targets or subjects in a region having a wide range, thereby making it possible to record information about every photographing target in a wide range.

Meanwhile, photographing with a camera using a telephoto lens or a zoom lens is performed in photographing of a sports event, photographing for television broadcasting, or the like, in order to obtain each scene at a crucial moment of each player at high definition. The fields of view of the telephoto lens and the zoom lens having a long focal length are narrow, so such photographing of each scene at a crucial moment is performed by tracking each photographing target such as a player.

Also, in order to photograph photographing targets in a wide range using a camera that uses a lens whose field of view is not so wide as that of the fish-eye lens, the wide-angle lens, or the like and is not so narrow as that of the telephoto lens or the zoom lens, there has been a technique with which photographing in a wide field of view is performed by arranging multiple cameras continuously or dispersedly.

In addition, there has also been a technique with which photographing in a wide field of view is performed by rotating (tilting or panning) a camera automatically or in response to an operator's manipulation.

Particularly, in order to obtain an ultra-high definition image in a photographing system, there has been a technique with which photographing is performed in a wide photographing range by rotating a camera with a zoom lens attached thereto in pan and tilt directions using a pan axis rotation stage and a tilt axis rotation stage while performing a zoom operation and a focus operation, and synthesizing multiple photographed images with each other, thereby obtaining a space image (see JP 2004-194075 A).

Also, JP 11-311832 A discloses a multi-focus camera in which two fixed focus lenses (optical systems) having different focal lengths and a shutter that is opened/closed with respect to each of the lenses are arranged in one lens-barrel, an image pickup element is arranged at a position (in-focus position) which opposes the shutter outside the lens-barrel at which subject images by the two lenses are imaged, and it is possible to switch a photographing screen between a tele screen (ordinary screen) having an ordinary screen size and a wide screen having a screen size that is larger than the ordinary screen size through an operation of the shutter, and also discloses a multi-focus camera in which three fixed focus lenses (optical systems) having the same focal length are arranged together with a shutter in one lens-barrel so that their distances from an image pickup element arranged outside differ from each other.

Further, JP 0-139878 A discloses an image system in which a camera array is obtained by arranging multiple (16 in a disclosed embodiment) television cameras (image pickup devices), each of which includes an image pickup element and a fixed focus lens (multi-focus lens) having two lens portions with different focal lengths, and is capable of imaging (focusing) a subject at a short distance and a subject at a long distance on the image pickup element to obtain an image that is in focus on both of a short-distance view and a long-distance view, thereby allowing multiple users to select in-focus images, in which no defocusing occurs, from among images in a wide range photographed by the camera array, at the same time and independently of one another.

Still further, JP 10-108057 A discloses a camera including a lens for imaging a subject image, a diaphragm circuit that sets a diaphragm value by obtaining a diaphragm value at which appropriate exposure is obtained, through calculation based on subject brightness or by inputting a manually set diaphragm value, and a control means for storing information concerning multiple subject distances and performing control so that photographing is repeated plural times while displacing a focus position of the lens at a predetermined diaphragm value when it has been judged that the stored multiple subject distances do not fall within depth of field at the diaphragm value set by the diaphragm circuit.

However, the amount of obtained information on each photographing target in an image photographed by a camera that uses a wide-angle lens is not so large, so it is impossible to obtain detailed information. As a result, definition as image information is lowered, which leads to a problem in that, for instance, it is impossible to obtain a high-definition image of a subject that is a photographing target. In particular, in the case of a camera using an ultra-wide-angle fish-eye lens, there occurs a problem in that an obtained image is distorted in its peripheral portion, which hinders to obtain a detailed image of a target. Therefore, when a camera using a fish-eye lens is applied to crime prevention, it is possible to photograph a wide range with one camera, but there has been a problem in that it is impossible to identify a face of a suspicious person.

Also, when a fish-eye lens or a wide-angle lens is applied to a camera for photographing or outside broadcasting of a sports event such as baseball or soccer, it is possible to photograph a wide range with one camera, but there has been a problem in that it is difficult to distinguish a face of a player from the other in a peripheral portion of an obtained image due to image distortion, definition insufficiency, or the like.

Meanwhile, in photographing of various sports events, photographing for television broadcasting, or the like, when a crucial moment is photographed with a camera using a telephoto lens or a zoom lens by tracking a photographing target, such as each player, it is possible to obtain information with a clear image of the photographing target, such as a player or a subject, which is set as a tracking target, but there occurs a problem in that it is impossible to obtain image information in a scene outside the field of view of the telephoto lens or the zoom lens.

In order to obtain clear image information, that is, detailed information of a subject that is a photographing target using a camera that uses an optical system such as an imaging lens, it is required that the camera is in focus on the subject (in-focus state is obtained for the subject). A range where the in-focus state is obtained for the subject is within a range of depth of field determined by the focal length and the diaphragm (brightness) of the optical system, that is, the lens. Outside the range of the depth of field, the in-focus state is not obtained for the subject and an obtained image becomes a so-called out-of-focus image. Note that as the lens focal length is increased, the depth of field is reduced.

Here, when a telephoto lens is used, its depth of field with respect to a long focal length is small, so there occurs a problem in that when a photographing target, such as a player, has moved in a direction of the depth of field, the depth of field is exceeded and it becomes impossible to obtain information of a clear image. Note that in a case where a zoom lens having a long focal length is used, even with its small depth of field with respect to a focal length, it is possible to obtain clear image information at all times, because it is possible to perform photographing within the depth of field while tracking a moving photographing target and adjusting the focal length, although there is a problem in that the photographing in such a manner is difficult to perform for a non-skilled person.

Also, when multiple cameras are installed and monitoring is performed for crime prevention, observation, or a survey, there occurs a problem in that many cameras are required in order to reduce a dead angle.

Further, when multiple cameras are installed for photographing or outside broadcasting of a sports event, each camera requires an operator. In addition, when it is impossible for the operator to follow a movement of a player or the like, there occurs a problem in that scene information cannot be obtained.

Still further, in a case where a space having a wide range is photographed by tilting or panning a camera automatically or in response to an operator's manipulation, in particular, in the photographing system disclosed in JP 2004-194075 A, a camera with a zoom lens attached thereto is used to pick up an image of a space having a wide range, so it is possible to obtain a high-definition image of the wide range, but it does not mean that a simultaneously photographable field of view is widened. Therefore, in such a case including the case of the photographing system disclosed in JP 2004-194075 A, there occurs a problem in that it is impossible to grasp respective events occurring at different locations even in a range where photographing is performed through camera tilting or panning.

Also, in JP 11-311832 A in which a multi-focus camera is realized using a simple construction, that is, a simple multi-focus optical system that includes, for instance, lenses having different focal lengths, merely the switching between the tele screen having the ordinary size and the wide screen having the larger size is performed using the shutter and it is impossible to photograph the tele screen and the wide screen at the same time. That is, like in the case of the photographing system disclosed in JP 2004-194075 A, a simultaneously photographable field of view is not widened and there is a problem in that it is impossible to grasp an event occurring in the tele screen while photographing the wide screen and vice versa.

Also, with the image system disclosed in JP 09-139878 A, it is possible to obtain an image that is in focus on both of a short-distance view and a long-distance view using one camera, although there has been a problem in that in order to photograph a space having a wide range, many television cameras (image pickup apparatuses) need to be used (16 cameras are used in the disclosed embodiment). Therefore, there is a problem in that the apparatus construction is increased in size and there is a fear that an unphotographable photographing region may be generated in some cases.

Also, with the camera disclosed in JP 10-108057 A, it is possible to obtain a photograph that is in focus on all of subjects at different distances using one camera, although there is a problem in that it is required to perform photographing multiple times while changing focus and therefore it is impossible to grasp all of events simultaneously occurring in a photographing range. Accordingly, when the subjects are moving, it is impossible to obtain an image at the time of start of the photographing.

### SUMMARY OF THE INVENTION

An object of the present invention is to solve the problems of the conventional techniques described above by providing a photographing system and a photographing method with which it is possible to obtain detailed image information across a wide range and therefore it is possible to photograph an image, in particular, a moving image of the entire region in a predetermined photographing spacetime at an arbitrary point in time in a predetermined photographing time at high definition and in real time.

In order to attain the above described object, a first aspect of the present invention provides a photographing system for photographing a predetermined photographing spacetime, comprising: image pickup modules having different focal lengths, each picking up an image in the predetermined photographing spacetime, wherein the image pickup modules are set such that a photographing magnification of the image pickup modules having a longer focal length is higher than a photographing magnification of the pickup modules having a shorter focal length.

In the present invention, the image pickup modules may be arranged such that, when one same target is photographed in the predetermined photographing spacetime, target images having the same size are obtained.

In the present invention, preferably, each of the image pickup modules having the different focal lengths has an in-focus range where a target of the same size is clearly picked up when the target of the same size is photographed at an arbitrary point in time in the photographing spacetime, wherein the image pickup modules having the different focal lengths are arranged such that respective in-focus ranges of the image pickup modules are continuous or partially overlap each other in a photographing direction.

Further, an image of the one same target may be clearly picked up in the in-focus range.

Preferably, the image pickup modules include groups of plural image pickup modules which are provided for each focal length and a group of plural image pickup modules having the same focal length photograph a photographing range of the predetermined photographing spacetime, which two-dimensionally extends in a direction orthogonal to the photographing direction.

And, in the present invention, it is preferable that the photographing system further comprises a display unit that displays an image photographed by each of the image pickup modules or a composite image of photographed images.

And, preferably, among the image pickup modules, the image pickup modules having long focal lengths are arranged densely as compared with the image pickup modules having short focal lengths.

Further, preferably, photographing magnifications of the image pickup modules are set such that, when a target of the same size is photographed at an arbitrary point in time in the photographing spacetime, the target images having the same size are obtained.

In the present invention, photographing magnifications of the image pickup modules may be set such that, when the one same target is photographed in the predetermined photographing spacetime, the target images having the same size are obtained.

Preferably, a photographing distance is set for each of focal lengths of the image pickup modules.

And, in the present invention, preferably, a photographing range is formed by a group of image pickup modules for each focal length and respective groups of image pickup modules are arranged such that centers of photographing ranges formed by the respective groups of image pickup modules having the same focal lengths are positioned on the same line.

Further, preferably, a first photographing range by a first group of image pickup modules having a short focal length is smaller than a second photographing range by a second group of image pickup modules having a long focal length.

And, preferably, a first photographing range by a first group of image pickup modules having a short focal length is larger than a second photographing range by a second group of image pickup modules having a long focal length.

Preferably, photographing timings of the image pickup modules are synchronized with each other.

Preferably, each of the image pickup modules includes a photoelectric conversion element that obtains image data of a photographing target by photoelectrically converting a target image of the photographing target.

A second aspect of the present invention provides a photographing method, comprising: using image pickup modules being set such that a photographing magnification of the image pickup modules having a longer focal length is higher than a photographing magnification of the pickup modules having a shorter focal length; and photographing the predetermined photographing spacetime.

Here, the image pickup modules may be arranged such that, when one same target is photographed in the photographing spacetime, target images having the same size are obtained.

With the photographing system and the photographing method according to the present invention, at least two kinds of image pickup modules having different focal lengths are used to pick up images of a predetermined photographing spacetime, and image pickup modules are set such that a photographing magnification of the image pickup modules having a longer focal length is higher than a photographing magnification of the image pickup modules having a shorter focal length so that when a target of the same size is photographed at an arbitrary point in time in the photographing spacetime, target images having the same size at all times are obtained. Therefore, it is possible to photograph an image, in particular, a moving image of the entire region in the photographing spacetime at an arbitrary point in time in a predetermined photographing time at high definition and in real time.

For instance, in the present invention, at least two image pickup modules having different focal lengths may be arranged such that, when one same target is photographed in the photographing spacetime, target images having the same size are obtained. Even with this construction, it is possible to pick up images of the same target in the photographing spacetime in the same size at all times, and it is possible to photograph an image, in particular, a moving image of the entire region in the photographing spacetime at an arbitrary point in time in a predetermined photographing time at high definition and in real time.

Also, with the photographing system and the photographing method according to the present invention, it becomes possible to obtain detailed image information with high definition across a wide range in a photographing spacetime, while eliminating the necessity for focus adjustment with respect to a target, for camera tilting or panning, and for operators that directly operate the image pickup modules. As described above, with the photographing system and the photographing method according to the present invention, it becomes possible to pick up the images of the target so as to obtain the target images having the same size at all times, when the target of the same size is photographed at an arbitrary point in time in the photographing spacetime and prevent a situation in which an obtained image is distorted. In addition, with the photographing system and the photographing method according to the present invention, it is possible to pick up images of the same target in the same size at all times in the photographing spacetime and prevent a situation in which an obtained image is distorted.

As a result, with the photographing system and the photographing method according to the present invention, the shutter can be released at the right moment. Also, lens drive mechanisms, such as a zoom mechanism and an autofocus mechanism, can be eliminated, which simplifies the construction. Accordingly, with the photographing system and the photographing method according to the present invention, it becomes possible to perform image recording with ease.

Further, with the photographing system and the photographing method according to the present invention, by using a photoelectric conversion element, such as an image sensor of CCD type or CMOS type, in the image pickup modules, it becomes possible to make the image pickup modules compact and also reduce the overall size of the system.

### BRIEF DESCRIPTION OF THE DRAWINGS

In the accompanying drawings:

FIG. 1 is a schematic diagram showing a photographing region by a photographing system according to a first embodiment of the present invention;

FIG. 2 is a schematic block diagram showing the photographing system according to the first embodiment of the present invention;

FIG. 3 is a block diagram showing an example of a construction of an image pickup unit of the photographing system in the first embodiment of the present invention;

FIG. 4 is a schematic diagram showing a monitor of the photographing system in the first embodiment of the present invention;

FIG. 5 is a schematic cross-sectional view showing an example of a concrete construction of an image pickup module constituting the image pickup unit of the photographing system in the first embodiment;

FIG. 6 is a schematic diagram for explanation of arrangement of a image pickup module of the photographing system according to the first embodiment of the present invention;

FIG. 7 is a schematic block diagram showing a photographing system according to a second embodiment of the present invention;

FIG. 8 is a schematic block diagram showing a photographing system according to a third embodiment of the present invention;

FIG. 9 is a schematic block diagram showing a photographing system according to a fourth embodiment of the present invention;

FIG. 10 is a side view showing an external appearance of the photographing system according to the fourth embodiment of the present invention;

FIG. 11 is a schematic partial cross-sectional view showing a state in which the photographing system in the fourth embodiment is installed at a store;

FIG. 12 is a schematic plan view showing a photographing range of each image pickup unit of the photographing system shown in FIG. 11;

FIG. 13 is a schematic diagram showing an arrangement state of the image pickup units of the photographing system according to the fourth embodiment of the present invention;

FIG. 14 is a schematic block diagram showing a first modification of the photographing system according to the fourth embodiment of the present invention; and

FIG. 15 is a schematic block diagram showing a second modification of the photographing system according to the fourth embodiment of the present invention.

### DETAILED DESCRIPTION OF THE PREFERRED EMBODIMENTS

Hereinafter, the photographing system and the photographing method according to the present invention will be described in detail based on preferred embodiments illustrated in the accompanying drawings.

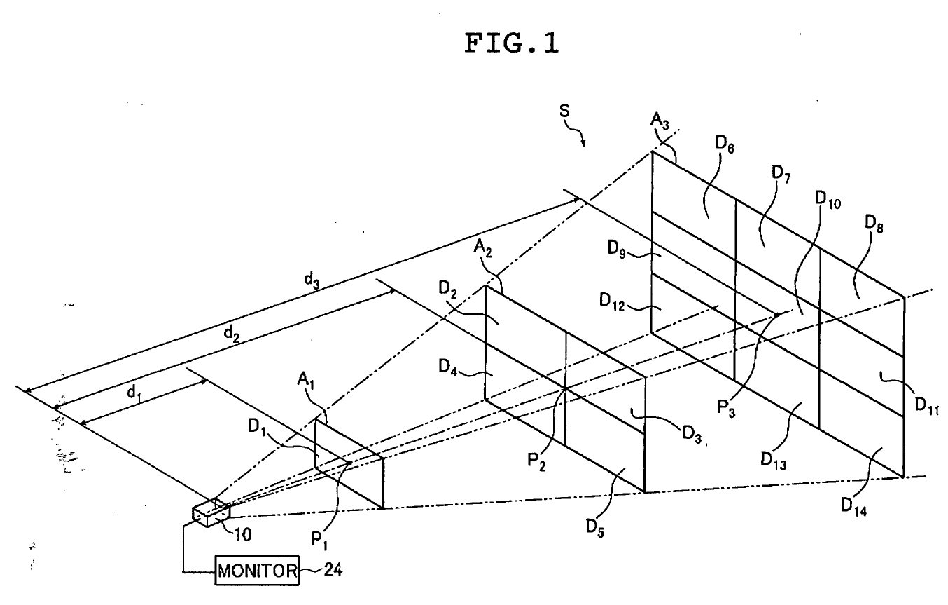

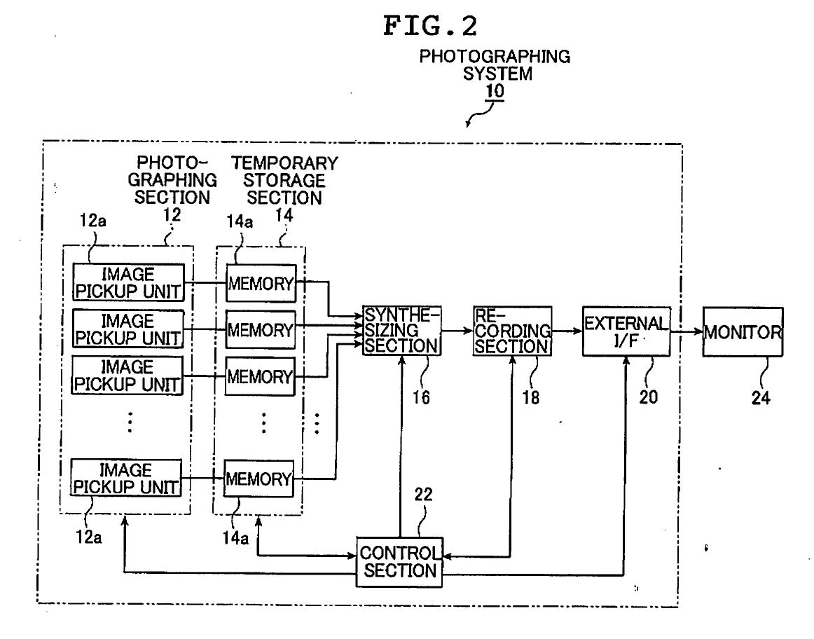

FIG. 1 is a schematic diagram showing a photographing region by a photographing system according to a first embodiment of the present invention. FIG. 2 is a schematic block diagram showing the photographing system according to the first embodiment of the present invention.

A photographing system 10 in this embodiment is a system that is capable of continuously photographing the whole of a predetermined photographing spacetime, that is, a predetermined photographing space S in an arbitrary photographing time.

As shown in FIG. 1, the photographing system 10 is provided with a monitor 24 for displaying a photographed image.

It should be noted here that in the photographing system 10 in this embodiment, as will be described later, the predetermined photographing space S is photographed at, for example, three different photographing distances d₁, d₂, and d₃ using, for example, 14 image pickup modules 26, although the present invention is not specifically limited to this.

In the photographing system 10 in this embodiment, a photographing range A₁ at the photographing distance d₁ is composed of one photographing region D₁, for instance. Also, a photographing range A₂ at the photographing distance d₂ is composed of four photographing regions D₂ to D₅, for instance. Further, a photographing range A₃ at the photographing distance d₃ is composed of nine photographing regions D₆ to D₁₄, for instance.

It should be noted here that in this embodiment, the photographing regions D₂ to D₅ each are a range that is photographed with one image pickup module and have the same area. Also, needless to say, a clear image in which an in-focus state is obtained at each of the photographing distances d₁, d₂, and d₃ is obtained by each image pickup module 26.

As shown in FIG. 2, the photographing system 10 according to the present invention basically including a photographing section 12, a temporary storage section 14, a synthesizing section 16, a recording section 18, an external interface (hereinafter referred to as the “external I/F”) 20, and a control section 22. A monitor 24 is connected to the external I/F 20.

Here, the photographing section 12 includes image pickup units 12a, and the temporary storage section 14 includes memories 14a that respectively correspond to the image pickup units 12a.

In the photographing system 10 shown in FIG. 2, a photographing means includes the photographing section 12 and the temporary storage section 14, and a data processing unit includes the synthesizing section 16, the recording section 18, the external I/F 20, and the control section 22. The photographing means and the data processing unit are integrated with each other.

In the present invention, the temporary storage section 14 includes the memories 14a whose number is equal to the number of the image pickup units 12a of the photographing section 12, and the memories 14a respectively correspond to the image pickup units 12a, although the present invention is not limited to this and one memory 14a may be provided for two or more image pickup units 12a or for all the image pickup units 12a. However, in order to obtain digital image data of a photographing target at the entire time or an arbitrary time in the entire space of a predetermined photographing spacetime, it is required to continuously take in image data from every image pickup unit 12a at the same time in parallel, so it is preferable that one memory 14a be provided for each of the-image pickup units 12a.

The photographing section 12 continuously photographs the whole of a photographing space (photographing target region) containing a subject that is a photographing target in the predetermined photographing spacetime. The photographing section 12 is provided with the minimum number of the image pickup units 12a required to photograph the entire space eliminating a dead angle in the photographing space. Images obtained by the image pickup units 12a are not specifically limited, and may be color images or monochrome images.

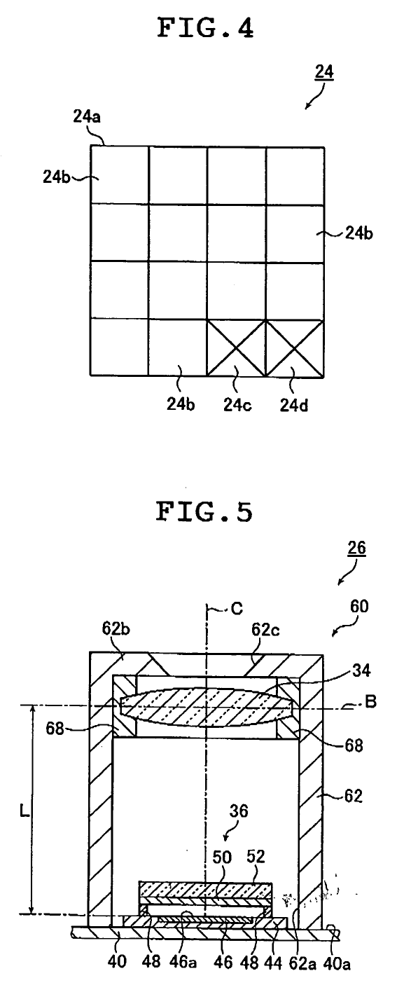

It should be noted here that in the photographing system 10 according to the present invention, each of the image pickup units 12a (image pickup modules 26 (see FIG. 4) to be described later) of the photographing section 12 has a predetermined focal length and an in-focus position at a predetermined position preset in the photographing space S that is the photographing target of the photographing system 10, sets the inside of a range (hereinafter referred to as the “in-focus range”) of depth of field with respect to the in-focus position as a predetermined photographing target space that is a preset photographing target region, and photographs a subject that is a photographing target existing in the photographing target space. By each of the image pickup units 12a, in the in-focus range, when a target of the same size is photographed, that is, when the same target is photographed, the same subject is photographed in the same size at all times. Also, in this embodiment, arrangement is made so that the image of the same target obtained by photographing the target of the same size (the same target) with each of the image pickup units 12a has the same size in the photographing range S.

Further, photographing timings of the image pickup units 12a are synchronized with one another, and the image pickup units 12a photograph the photographing space S at the same timing. The synchronization among the photographing timings is established using a clock generated by the control section 22 or the like, for example.

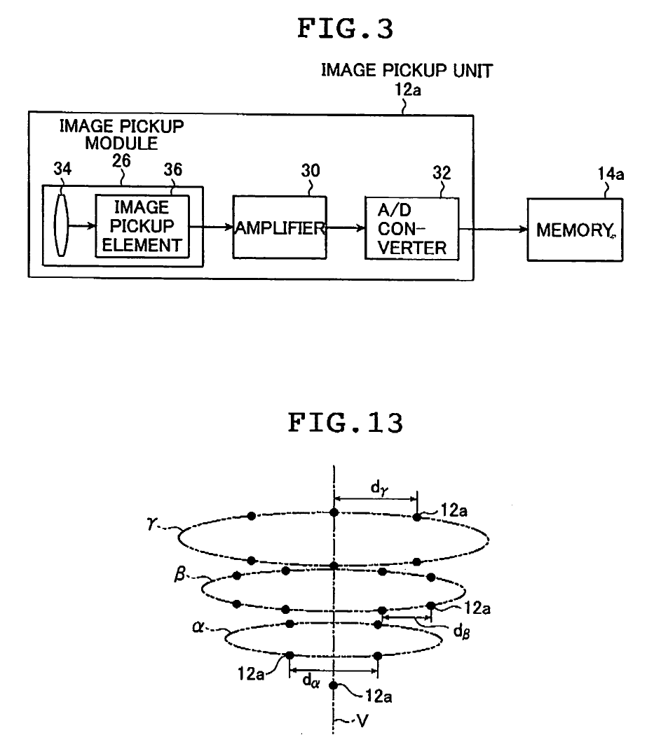

Here, FIG. 3 is a block diagram showing an example of a construction of the image pickup units of the photographing system in this embodiment. In the present invention, the image pickup units 12a have basically the same construction except for their in-focus positions, that is, their lens constructions in the image pickup modules to be described later that change in accordance with focal lengths, so the image pickup unit 12a shown in FIG. 3 will be described as a representative example and the description of the other image pickup units will be omitted.

As shown in FIG. 3, the image pickup unit 12a includes an image pickup module 26, an amplifier 30, and an A/D converter 32.

The image pickup module 26 is a module in which the image pickup unit 12a has a preset in-focus position and photographing target region or space and obtains an image signal by photographing an image of a photographing target in the photographing target region (space) as described above, and includes an imaging lens 34 having a predetermined focal length for setting the in-focus position possessed by the image pickup unit 12a and the photographing target region or space and an image pickup element 36 (that photoelectrically converts light bearing image information) to read a photographed image in the photographing target region imaged by the imaging lens 34 as image information (image signal).

The imaging lens 34 is not specifically limited so long as it is a lens having a required focal length and it is possible to use a known imaging lens, although it is possible to favorably use a small-sized imaging lens such as, in particular, a high-performance and small-sized lens applied to a mobile telephone with a camera or the like in recent years.

Also, the image pickup element 36 is an element that converts light bearing image information of a photographing target into electric charges. In other words, the image pickup element 36 performs electric signal conversion into an analog image signal through photoelectric conversion. As the image pickup element 36, it is possible to use, for example, an image sensor of CCD type or an image sensor of CMOS type.

It should be noted here that the detailed construction of the photographing section 12 and concrete constructions of the image pickup module 26, the imaging lens 34, and the image pickup element 36 will be described in detail later with reference to FIG. 5.

The amplifier 30 is used to amplify an analog image signal (electric charges) obtained by the image pickup module 26 in accordance with the photographing target. Note that when the strength of the analog image signal obtained by the image pickup module 26 is sufficient (when the amount of the electric charges is sufficient), the amplifier 30 is not necessarily required.

The A/D converter 32 is used to convert the analog image signal (electric charges) obtained in accordance with the photographing target and amplified by the amplifier 30 into a digital image signal (data) and outputs the digital image data to the memory 14a. That is, the image data of the photographing target is converted into the digital signal by the A/D converter 32 and the digital image data is recorded onto the memory 14a.

Meanwhile, the temporary storage section 14 is used to temporarily store the image of the photographing target picked up by each of the image pickup units 12a of the photographing section 12 as digital image data. In the photographing system 10 according to the present invention, the temporary storage section 14 is required to continuously take in images of the photographing target photographed by the photographing section 12 as moving images in real time in a predetermined photographing time from a predetermined point in time. Therefore, the temporary storage section 14 is provided with memories 14a that respectively correspond to the image pickup units 12a of the photographing section 12, with each of the memories 14a sequentially and temporarily storing the digital image data of the photographed image continuously outputted from its corresponding image pickup unit 12a connected thereto.

With this construction, the temporary storage section 14 is capable of sequentially and continuously taking in the digital image data of the photographed image from each of the image-pickup units 12a corresponding to the memories 14a as moving image data.

As the memory 14a, for instance, it is possible to use a semiconductor memory, such as an SRAM or a DRAM, or a combination thereof.

The synthesizing section 16 is connected to all of the memories 14a of the temporary storage section 14, reads out the digital image data of the image photographed by each of the image pickup units 12a (image pickup modules 26) from the memories 14a, and synthesizes the images photographed by several image pickup units 12a (image pickup modules 26) having different in-focus positions with respect to a photographing direction of the photographing space as a continuous synthesized image so that particularly the images of the same photographing target (subject) are reproduced in the same size. A digital image processing method for synthesizing the digital image data is not specifically limited and a known synthesizing processing method or software or the like may be used.

The recording section 18 is connected to the synthesizing section 16 and records and saves the digital image data of the synthesized image generated and outputted by the synthesizing section 16, in a readable and writable manner. As the recording section 18, a semiconductor storage element (memory) such as a volatile memory (e.g., an SRAM or a DRAM), or a nonvolatile memory (e.g., an EPROM, an EEPROM, or a flash memory), a recording medium such as a hard disk, an optical disk, a magneto-optical disk, a magnetic disk, or a magnetic recording tape, or a combination thereof is used, for instance.

The external I/F 20 is connected to the recording section 18, reads out the digital image data of the synthesized image saved in the recording section 18, and transmits or delivers the read-out image data to various apparatuses that deal with image data such as the monitor 24, an external PC, an external image processing apparatus, and an external media drive in a wired or wireless manner or through the Internet, a LAN, or the like. Then, various images, such as the image obtained by each of the image pickup units 12a or the synthesized image, are displayed on the monitor 24, data processing or image processing of the image data of the synthesized image is performed at the external PC or the external image processing apparatus, and the image data of the synthesized image is recorded onto an external medium.

As the external I/F 20, a known I/F for digital data transmission or communication need only be used. When it is possible to record the image data of the synthesized image on a recording medium or the like at the recording section 18, the external I/F 20 may be omitted, although it is preferable that the external I/F 20 be provided in the photographing system 10 according to the present invention.

The control section 22 controls image pickup at the photographing section 12 (image pickup units 12a), writing/readout of digital image data into/from the temporary storage section 14 (memories 14a), image synthesizing processing at the synthesizing section 16, writing/readout of a synthesized image into/from the recording section 18, transmission/reception of image data by the external I/F 20, and image display on the monitor 24. The image display on the monitor 24 includes still image or moving image display.

Also, although not shown, the control section 22 may be connected to an interface, a keyboard, a mouse, a monitor, a scanner, and a media drive for various recording media.

It should be noted here that the control section 22 may include an image processing function that performs image processing on the image data temporarily stored in the temporary storage section 14 (memories 14a).

Also, in this embodiment, a construction is used in which image data is outputted to the synthesizing section 16 and the recording section 18, although the present invention is not limited to this. For instance, the image data may be directly outputted from the temporary storage section 14 to the external I/F 20 through the control section 22 and displayed on the monitor 24.

The monitor 24 is connected to the external I/F 20 and displays the image obtained through photographing by the photographing section 12.

Also, the monitor 24 receives input of the digital image data of the synthesized image generated and outputted by the synthesizing section 16, and displays at least a part or the whole of the synthesized image.

It should be noted here that in the photographing system 10 in this embodiment, multiple image pickup modules 26 area provided. Therefore, based on the image data temporarily stored in the temporary storage section 14 (memories 14a), through control by the control section 22, for instance, switching between the memories 14a respectively corresponding to the image pickup units 12a is performed continuously or intermittently to display the image obtained by each image pickup unit 12a (each image pickup module 26) on the monitor 24.

In this case, as shown in FIG. 4, a screen 24a of the monitor 24 is divided into display regions 24b whose number is equal to or larger than the number of the image pickup modules 26 provided (i.e., 16 display regions 24b in this embodiment), and all of 14 images obtained by the respective image pickup modules 26 are displayed in the display regions 24b in real time. Note that the monitor 24 is divided into 16 regions, so the images obtained by the image pickup modules 26 are not displayed in the display regions 24c and 24d.

In this embodiment, many image pickup units 12a (image pickup modules 26) are provided, so images photographed by groups of several image pickup units 12a among all of the image pickup units 12a and synthesized by the synthesizing section 16 may be displayed on the monitor 24 sequentially and. intermittently while performing switching among the groups of the image pickup units 12a. Further, the screen of the monitor 24 may be divided into display regions whose number is equal to the number of the groups of the image pickup units 12a, and all of the synthesized images obtained by the respective groups of the image pickup units 12a may be displayed in real time.

All of the images obtained by the image pickup units 12a may be joined to one another by the synthesizing section 16 and displayed on the monitor 24. Also, images for the respective photographing ranges A₁ to A₃ may be created in the synthesizing section 16 and the synthesized images may be displayed on the monitor 24 successively or intermittently.

It should be noted here that as the monitor 24, for instance, it is possible to use a CRT display apparatus, a liquid crystal display (LCD) apparatus, a plasma display apparatus, or an organic EL display apparatus. Also, the number of display regions into which the screen of the monitor 24 is divided, is not limited to 16 as long as the monitor screen is divided into display regions whose number is equal to or larger than the number of the image pickup modules 26 provided in the photographing system 10. Further, it is preferable that the monitor 24 be capable of performing displaying while appropriately changing the number of the display regions in accordance with the form of display on the monitor 24. The photographing system 10 according to the present invention is basically constructed in the manner described above.

FIG. 5 is a schematic cross-sectional view showing an example of a concrete construction of an image pickup module constituting the image pickup unit of the photographing system in this embodiment. In the present invention, the image pickup modules have the same construction except for the lens focal lengths that change depending on the arrangement positions, so only one image pickup module will be described and the description of the other image pickup modules will be omitted. In FIG. 5, the amplifier 30 and the A/D converter 32 are not shown.

As shown in FIG. 5, the image pickup module 26 of the photographing system 10 in this embodiment basically includes an imaging lens 34, an image pickup element 36, and a lens-barrel 60.

In the image pickup module 26, the image pickup element 36 is mounted on a surface 40a of a flexible printed circuit (hereinafter referred to as the “FPC”) 40. The lens-barrel 60 is provided so as to surround the image pickup element 36.

Also, a substrate 44 and the FPC 40 are connected to each other by a mounting means such as wire bonding or tape automated bonding (TAB).

The image pickup element 36 includes a CCD image sensor (hereinafter referred to as the “CCD sensor”), for instance. In the image pickup element 36, a light-receiving region 46 in which light-receiving portions (not shown) formed by photodiodes are arranged in a lattice manner is formed on the substrate 44, for instance. Also, the amplifier 30 (see FIG. 3) and the A/D converter 32 (see FIG. 3) that are not shown in FIG. 5 are formed on the substrate 44. Further, members such as a shift register that are necessary to form the CCD are formed on the periphery of the light-receiving region 46. Accordingly, the image pickup module 26 shown in FIG. 5 substantially corresponds to the image pickup unit 12a.

Also, a partition wall 48 is formed on a surface of the substrate 44 so as to surround the periphery of the light-receiving region 46 and a cover glass 50 is provided so as to cover a region surrounded by the partition wall 48. Consequently, the light-receiving region 46 is sealed by the cover glass 50.

Further, as to the image pickup element 36, an infrared cut filter 52 is provided on the upper surface of the cover glass 50.

The lens-barrel 60 includes a cylindrical enclosure 62, with one end portion of the enclosure 62 being closed and the other end portion thereof being opened. The other end portion of the enclosure 62 is firmly attached onto the surface 40a of the FPC 40 using an adhesive or the like. Also, the enclosure 62 has an inside diameter with which it is possible to internally accommodate the substrate 44, and the substrate 44 is accommodated in an opening portion 62a.

For a closed surface 62b on the one-end-portion side of the enclosure 62, a through hole 62c through which photographing light enters, is formed about a position corresponding to the center axis C of the enclosure 62. Also, within the one end portion of the enclosure 62, the imaging lens 34 is provided through a lens holder 68.

It should be noted here that the center axis C coincides with the optical axis of the imaging lens 34. Accordingly, the image pickup module 26 shown in FIG. 5 substantially corresponds to the image pickup unit 12a.

In this embodiment, image pickup modules 26 having different focal lengths are used depending on the image pickup units 12a used. In each image pickup module 26, the focal length is adjusted by changing the focal length of the imaging lens 34, and the distance L between a line B passing through the pupil position of the imaging lens 34 and a light-receiving surface 46a of the light-receiving region 46 correspondingly. In addition, when having different focal lengths, the image pickup modules are set such that a photographing magnification of the image pickup modules having a longer focal length is higher than a photographing magnification of the image pickup modules having a shorter focal length. Other constructions of the image pickup modules are the same regardless of the focal lengths. Each image pickup module 26 may include an optical zoom mechanism, a mechanical zoom mechanism, or an electronic zoom mechanism, and change its photographing magnification using the mechanism.

The image pickup element 36 includes a CCD sensor. As a method of manufacturing the CCD sensor, for instance, there is a manufacturing method with which many light-receiving regions or the like corresponding to CCD sensors are formed on a silicon wafer, the silicon wafer is diced into rectangular chips that respectively correspond to the CCD sensors, a partition wall is formed on each chip, and the light-receiving region and the like is sealed by placing a cover glass on the partition wall.

Aside from this, there is also a CCD sensor manufacturing method with which many light-receiving regions or the like corresponding to CCD sensors are formed on a silicon wafer, partition walls are formed for example in a lattice manner so as to correspond to respective CCD sensors, a cover glass is bonded so as to cover every CCD sensor, and dicing is performed so that the partition walls 48 are cut in half.

It should be noted here that the image pickup element 36 is not specifically limited so long as it is a solid-state image pickup element and it is also possible to use a CMOS sensor. By using the solid-state image pickup element as the image pickup element 36, it becomes possible to reduce the size of the image pickup module 26.

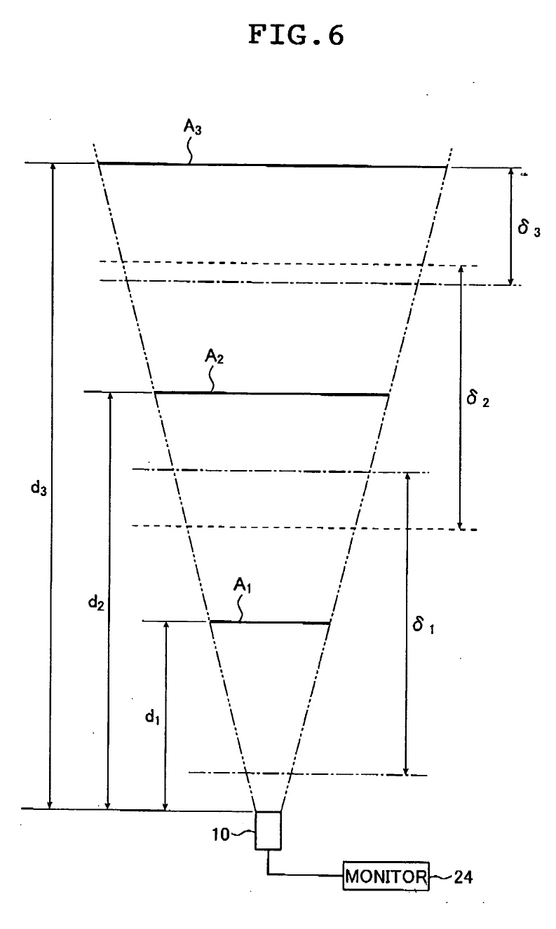

Arrangement of the image pickup units 12a (image pickup modules 26) of the photographing section 12 in the present invention will be described with reference to FIGS. 1 and 6.

Here, FIG. 6 is a schematic diagram for explanation of the arrangement of the image pickup modules of the photographing system according to the first embodiment of the present invention.

In the present invention, as the image pickup units 12a (image pickup modules 26) of the photographing section 12, three kinds of units that respectively have focal lengths f₁ to f₃ are used, for instance. In this embodiment, the focal lengths f₁ to f₃ are in a relation of f₁<f₂<f₃, for instance. Here, the photographing magnification is also set so as to become higher in the order of the following: focal length f₁<focal length f₂<focal length f₃.

In this embodiment, the arrangement is made so that the image pickup unit 12a having the shortest focal length (focal length f₁) photographs the photographing region D₁ at the photographing distance d₁. Also, the arrangement is made so that the image pickup units 12a having the next shortest focal length (focal length f₂) photograph the photographing regions D₂ to D₅ at the photographing distance d₂. Further, the arrangement is made so that the image pickup units 12a having the longest focal length (focal length f₃) photograph the photographing regions D₆ to D₁₄ at the photographing distance d₃. In the manner described above, according to the present invention, the photographing distances d₁ to d₃ and the photographing magnification are set for the focal lengths f₁ to f₃.

In this embodiment, in order to photograph a range in a photographing direction based on an angle of view of the image pickup unit 12a photographing the photographing range Al (photographing region D₁) at the photographing distance d₁, it is required to photograph the photographing range A₂ at the photographing distance d₂. The photographing range A₂ includes the photographing regions D₂ to D₅ photographed by four image pickup units 12a. The photographing regions D₂ to D₅ in the photographing range A₂ are contiguous with one another.

Also, at the photographing distance d₃, it is required to photograph the photographing range A₃. The photographing range A₃ includes the photographing regions D₆ to D₁₄ photographed by nine image pickup units 12a. The photographing regions D₆ to D₁₄ in the photographing range A₃ are contiguous with one another.

In the manner described above, in this embodiment, in order to photograph the photographing space S, 14 image pickup units 12a are provided in total, with the image pickup modules 12a having longer focal lengths being arranged more densely. Note that there occurs no problem even when the photographing regions D₂ to D₁₄ in the photographing ranges A₂ and A₃ partially overlap one another so long as it is possible to photograph the range based on the angle of view of the image pickup unit 12a that photographs the photographing region D₁. In this case, photographed images are image-processed by the synthesizing section 16 and are converted into one image.

Further, the image pickup units 12a have in-focus ranges in which a target of the same size is photographed at an arbitrary point in the photographing space S, it is possible to pick up images of the target having the same size clearly, i.e., it is possible to pick up images of the same target clearly.

The in-focus ranges are set in accordance with the focal lengths f₁ to f₃, for instance. As shown in FIG. 6, for example, the image pickup unit 12a corresponding to the photographing distance d₁ (focal length f₁) has an in-focus range δ₁. Also, the image pickup units 12a corresponding to the photographing distance d₂ (focal length f₂) have an in-focus range δ₂. Further, the image pickup units 12a corresponding to the photographing distance d₃ (focal length f₃) have an in-focus range δ₃.

According to the present invention, the image pickup modules 12a are arranged so that the in-focus ranges δ₁ to δ₃ partially overlap one another with respect to the photographing direction. With this construction, in the photographing direction, when a target of the same size is photographed, i.e., when the same target is photographed at an arbitrary point in time in the photographing space S, it becomes possible to photograph the target in the same size at all times. Note that it is not required that the in-focus ranges δ₁ to δ₃ overlap one another, and the adjacent in-focus ranges δ₁ to δ₃ need only be in contact with one another so that the in-focus ranges δ₁ to δ₃ are contiguous with one another.

Also, according to the present invention, it is preferable that the image pickup modules 12a be arranged so that the centers P₁ to P₃ of the photographing ranges A₁ to A₃ are positioned on the same line. Further, in this embodiment, the size of the photographing ranges A₁ to A₃ is sequentially increased along with the increase of the photographing distance from d₁ to d₃, although the present invention is not limited to this. For instance, the size of the photographing ranges Al to A₃ may be sequentially reduced along with the increase of the photographing distance from d₁ to d₃. Also, the size of the photographing range A₂ corresponding to the photographing distance d₂ may be set as the maximum and the size of the other photographing ranges A₁ and A₃ may be reduced.

Also, the image-pickup modules 12a are arranged so that it is possible to photograph the entire region in the photographing space S. Therefore, the image pickup modules 12a are arranged so that it is also possible to photograph two dimensional planes at the respective photographing distances d₁ to d₃ so that the photographing ranges A₁ to A₃ cover the entire region of the photographing space S in a direction orthogonal to the photographing direction.

Further, in the present invention, it is preferable that photographing magnifications in the photographing ranges A₁ to A₃ by the image pickup modules 12a be precisely set at predetermined magnifications so that, when a target of the same size is photographed, i.e., when the same target is photographed at an arbitrary point in time in the photographing space S, the target is photographed in the same size at all times. In this case, the image pickup modules 12a are provided so that the photographing magnifications fall within predetermined ranges in the in-focus ranges δ₁ to δ₃. With this construction, in images obtained by the image pickup modules 12a, the same target is photographed in the same size in the photographing space S. Therefore, it becomes possible to precisely recognize the target from images displayed on the monitor 24 or printed-out images regardless of the photographing distances.

Also, according to the present invention, it is preferable that the image pickup modules 12a be arranged at the optimum photographing distance. With this construction, it becomes possible to determine a distance to the target photographed by the image pickup modules. By arranging the image, pickup units 12a in this manner, it becomes possible to obtain the geometry such as the size of the subject with high accuracy from the images obtained by the image pickup modules 26.

In the photographing system 10 in this embodiment, at least two image pickup modules 26 having different focal lengths are provided and arranged so that, when the target of the same size is photographed, i.e., when the same target is photographed at an arbitrary point in time in the photographing space S, the same size is obtained at all times, thereby making it possible to pick up images of the target having the same size, i.e., the same target in the same size at all times in the photographing space S. Therefore, it becomes possible to photograph an image, in particular, a moving image at an arbitrary point in time in a predetermined photographing time in the entire region in the photographing space S at high definition and in real time. As a result, it becomes possible to perform image recording with ease and an optimum image recording timing is not missed.

Also, in the photographing system 10 in this embodiment, it becomes possible to display an obtained image on the monitor 24 and record the image in various forms. Further, in the photographing system 10 in this embodiment, it becomes possible to synthesize images photographed by the image pickup modules 26 and display the synthesized images on the monitor 24.

Also, in the photographing system 10 in this embodiment, focus adjustment of a camera and tilting or panning of the camera are not necessary, nor requires the system 10 an operator that directly operates the image pickup modules. Therefore, lens drive mechanisms such as a zoom mechanism and an autofocus mechanism become unnecessary, thereby simplifying the construction of the photographing system 10.

Next, a second embodiment of the photographing system according to the present invention will be described.

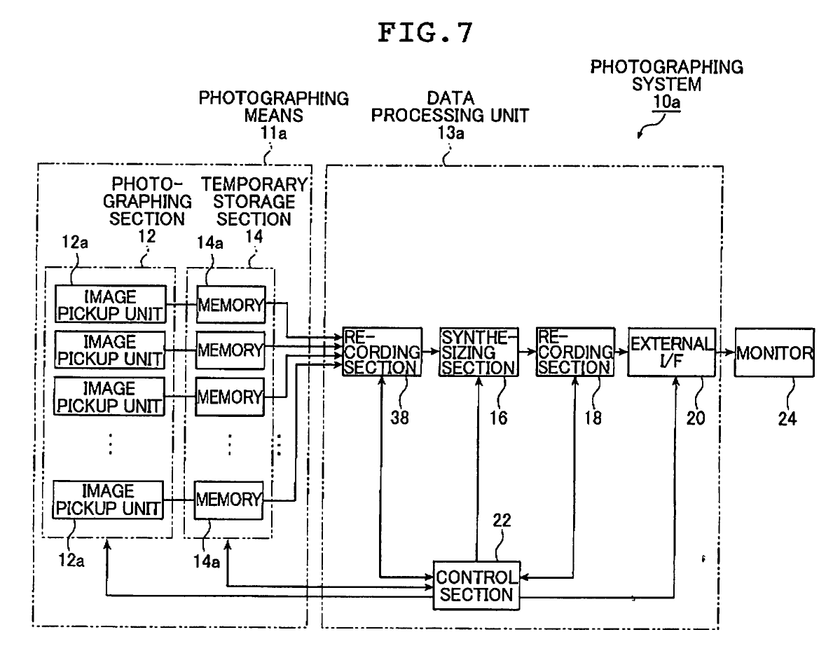

FIG. 7 is a schematic block diagram showing a photographing system according to the second embodiment of the present invention.

A photographing system 10a shown in FIG. 7 has the same construction as the photographing system 10 in the first embodiment shown in FIG. 2 except that a recording section 38 is provided between a temporary storage section 14 and a synthesizing section 16, and a photographing means 11a and a data processing unit 13a are separated from each other, so the same construction elements are given the same reference symbols and the detailed description thereof will be omitted.

The photographing system 10a in this embodiment includes the photographing means 11a and the data processing unit 13a that are separated from each other and connection therebetween is established by a signal line.

The photographing means 11a includes a photographing section 12 and the temporary storage section 14 and the data processing unit 13a includes the recording section 38, the synthesizing section 16, a recording section 18, an external I/F 20, and a control section 22.

Here, the recording section 38 of the data processing unit 13a reads out digital image data temporarily stored in each of the memories 14a of the temporary storage section 14 of the photographing means 11a and saves the read-out data in a readable and writable manner.

Therefore, the synthesizing section 16 reads out digital image data of images photographed by image pickup modules from the recording section 38 and synthesizes images of a predetermined photographing target photographed by the image pickup modules having different in-focus positions with respect to the photographing direction in the photographing space of the photographing system 10a as a contiguous synthesized image.

The photographing system 11a in this embodiment includes the recording section 38, where the whole of digital image data obtained in a predetermined photographing spacetime is saved, so it is of course possible to omit the recording section 18 that records/saves the synthesized image. The synthesized image has a smaller amount of data and therefore is suitable for image data analysis in post processing but original data is better when precise analysis is to be performed. Accordingly, whether the recording section 18 is provided may be determined in accordance with a required purpose.

In the photographing system 10a in this embodiment, the photographing means 11a and the data processing unit 13a are separated from each other, so it becomes possible to arrange only the photographing means 11a at a required place and arrange the data processing unit 13a that an operator must monitor and operate at another place separately from the photographing means 11a. Therefore, the photographing system 10a of the present invention can be used as a monitoring system for crime prevention at a store such as a convenience store. For instance, when the photographing system 10a in the present invention is applied to crime prevention at a store such as a convenience store, the photographing means 11a is attached to the ceiling or an upper portion of a side wall of the store in which customers are not hindered from moving, the data processing unit 13a is arranged outside the store as in an office behind the store or inside a counter in which a cash register is arranged, and connection therebetween is established by a communication cable, thereby achieving an effective monitoring system for crime prevention.

Also, in this embodiment, a construction is used in which image data is outputted from the recording section 38 to the synthesizing section 16 and the recording section 18, although the present invention is not limited to this. The image data may be directly outputted from the recording section 38 to the external I/F 20 and displayed on the monitor 24. Note that even in the photographing system 10a in this embodiment, the same effect as in the case of the photographing system 10 in the first embodiment is achieved.

Next, a third embodiment of the photographing system according to the present invention will be described.

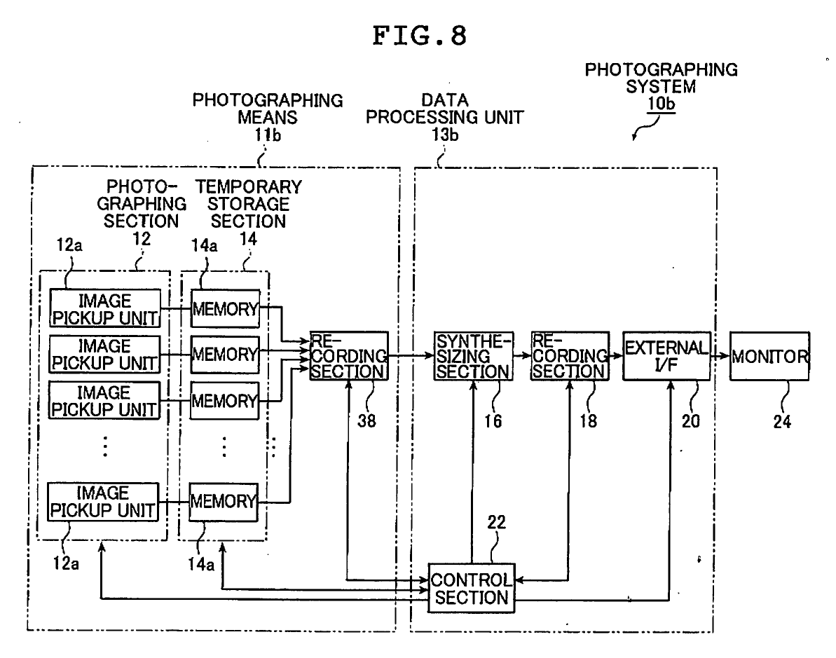

FIG. 8 is a schematic block diagram showing a photographing system according to the third embodiment of the present invention.

A photographing system 10b shown in FIG. 8 has the same construction as the photographing system 10a in the second embodiment shown in FIG. 7 except that a recording section 38 is not provided on a data processing unit 13b side but on a photographing means 11b side, so the same construction elements are given the same reference symbols and the detailed description thereof will be omitted.

The photographing system 10b in this embodiment includes the photographing means 11b and the data processing unit 13b that are separated from each other, and connection therebetween is established by a signal line.

The photographing means 11b includes a photographing section 12, a temporary storage section 14, and the recording section 38 and the data processing unit 13b includes a synthesizing section 16, a recording section 18, an external I/F 20, and a control section 22.

Here, the recording section 38 of the photographing means 11b reads out digital image data temporarily stored in memories 14a of the temporary storage section 14 and saves the read-out data in a readable and writable manner.

Therefore, the synthesizing section 16 of the data processing unit 13b reads out digital image data of images photographed by image pickup modules from the recording section 38 of the photographing means lib and synthesizes images of a predetermined photographing target photographed by the image pickup modules having different in-focus positions with respect to the photographing direction in the photographing space of the photographing system 10b as a continuous synthesized image.

In the photographing system 10b in this embodiment, the recording section 38 is provided on the photographing means 11b side, so it is unnecessary to process a large amount of image data in succession and in real time when the digital image data is read out from the recording section 38. However, in the photographing system 10a shown in FIG. 7, the recording section 38 of the data processing unit 13a is required to read out and record the digital image data temporarily stored in the memories 14a of the temporary storage section 14 of the photographing means 11a in real time and in succession, so a signal line that enables readout in real time must be provided between the photographing means 11a and the data processing unit 13a.

Accordingly, for instance, when the photographing system 10b in the present invention is applied to crime prevention at a store such as a convenience store, it becomes possible to realize a more effective monitoring system for crime prevention.

Also, in this embodiment, a construction is used in which image data is outputted from the recording section 38 to the synthesizing section 16 and the recording section 18, although the present invention is not limited to this. The image data may be directly outputted from the recording section 38 to the external I/F 20 and displayed on the monitor 24. Even in the photographing system 10b in this embodiment, the same effect as in the case of the photographing system 10 in the first embodiment is achieved.

The photographing system of the present invention is applicable not only to monitoring at a store as the monitoring system or the like, other monitoring or photographing for crime prevention, or monitoring or photographing of a person or an object but also to photographing, recording, outside broadcasting, or broadcasting of a sports event, or recording or inspection of an accident that occurred on a road or the like. The photographing system of the present invention is also applicable to observation of an agricultural product, a natural phenomenon such as a collision phenomenon, or a disaster such as an earthquake or tsunami. Further, the photographing system of the invention is generally applicable to any purpose so long as a camera is used.

Examples of the photographing space are a station, a station yard, a intersection, a road or a tollgate of an expressway, a parking lot, a construction site, a harbor, an airport, a railroad, the inside of an automobile, an airplane, a ship, or the like, a school like a kindergarten, a nursery school, an elementary school, a junior high school, a high school, or a university, a company, a residence such as a condominium, an open space, an art gallery, a museum, a library, a race track, an amusement park, a soccer field, a baseball ground, an athletics stadium, a tennis court, a pool, a skating rink, an arena, an indoor/outdoor stadium or game hall like a gymnasium where basketball, volleyball, or the like is played, a campground, a farm, a river and a mountain.

Also, in the photographing system of the present invention, it is also possible to edit a recorded image, record the edited image on a storage medium such as a CD, a DVD, or a video tape, and provide the storage medium.

Further, by mounting the photographing system of the present invention on an automobile, a motorcycle, or a bicycle, image recording becomes possible until the moment just before an accident occurs. In this case, it is preferable that the recording section saves image data from about one hour before the accident. There is a possibility that the recording section will be damaged at the time of an accident due to shock or fire, so it is preferable that the recording section be provided outside a car or the like.

Next, a fourth embodiment of the present invention will be described.

In the fourth embodiment of the present invention, the photographing system according to the present invention is applied to a monitoring system for crime prevention at a store such as a convenience store.

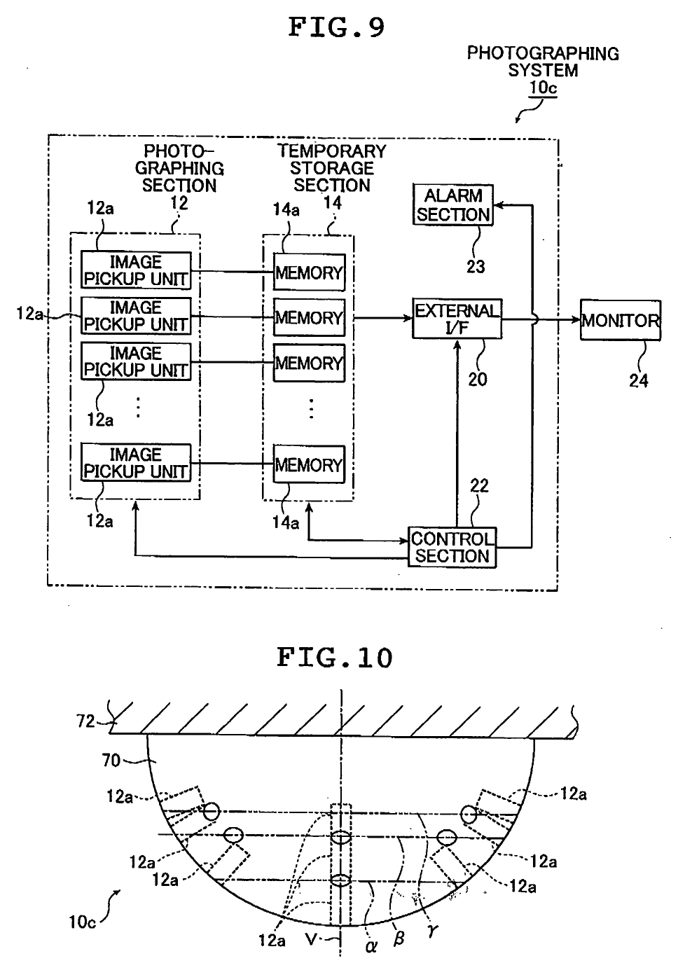

FIG. 9 is a schematic block diagram showing a photographing system according to the fourth embodiment of the present invention.

A photographing system 10c shown in FIG. 9 has the same construction as the photographing system 10 in the first embodiment shown in FIG. 2 except that the system 10c includes neither the synthesizing section 16 nor the recording section 18, the system 10 includes an alarm section 23, a temporary storage section 14 and a control section 22 have different functions from those in the first embodiment, so the same construction elements are given the same reference symbols and the detailed description thereof will be omitted.

The photographing system 10c in this embodiment includes the temporary storage section 14 and the alarm section 23, with the alarm section 23 being controlled by a control section 22.

The temporary storage section 14 in this embodiment doubles as the storage section 18 (see FIG. 2) of the photographing system 10 in the first embodiment. Also, image data stored in the temporary storage section 14 is outputted to the control section 22. As each memory 14a of the temporary storage section 14, a semiconductor storage element such as an SRAM or a DRAM, a hard disk, a magnetic recording tape, or a combination thereof is used, for instance.

In addition to the function of the control section 22 in the first embodiment, the control section 22 in this embodiment has an image processing function of performing image processing on the image data stored in the temporary storage section 14, an image registration function, a discrimination function of discriminating whether a photographed image is a registered image, and an image tracking function of extracting a specific target from images photographed by image pickup units 12a and tracking the extracted specific target.

In this embodiment, when image registration is performed using the image registration function, an image that should be registered is inputted from a scanner or a recording medium and is registered. When doing so, the control section 22 calculates the image characteristic amount of the registered image and saves the registered image and the image characteristic amount in relation to each other. As the image characteristic amount, a density pattern or a contour image obtained through binarization processing is used, for instance.

The discrimination function is a function of discriminating whether a photographed image is a registered image by calculating the image characteristic amount of the photographed image and comparing the obtained image characteristic amount with the registered image characteristic amount of the registered image using a correlation coefficient or the like.

The image tracking function is a function of tracking a specific target in a photographing target region by repeatedly performing an operation which includes calulating the image characteristic amount for each of images photographed by the image pickup units 12a and extracting a specific image therefrom through comparison with the image characteristic amount of a predetermined registered image, for instance. The control section 22 is also capable of recording a result of the image tracking in the recording section 18. Aside from this, a target image designated by an operator may be used as the registered image.

In addition, when discriminating that the photographed image is not a registered image, the control section 22 outputs an alarm signal to the monitor 24 or the alarm section 23 to thereby cause the monitor 24 or the alarm section 23 to issue a warning. For instance, when the photographing system is applied to crime prevention and a not registered person is confirmed, a warning is issued. In such a case, a door may be locked using an interlocking device.

On receiving the alarm signal from the control section 22, the alarm section 23 calls operator's attention by means of at least one of a voice signal and a light signal.

At the alarm section 23, a speaker or the like generates the voice signal. More specifically, a warning sound is emitted from the speaker. On the other hand, a light-emitting element such as a light or an LED generates the light signal. More specifically, the light-emitting element is turned on or flashes.

When the photographing system 10 in this embodiment is applied to a monitoring system, if an operator watches the monitor 24, it is not necessarily required to issue a warning using the alarm section 23 or display a warning screen giving an alarm on the monitor 24. However, in order to alleviate a load placed on the operator, it is preferable that an alarm be automatically issued by the alarm section 23.

FIG. 10 is a side view showing the external appearance of the photographing system according to the fourth embodiment of the present invention. The photographing system 10c in this embodiment performs photographing in all directions covering 360°.

As shown in FIG. 10, the photographing system 10c includes the photographing section 12 (see FIG. 9) and the temporary storage sections 14 (see FIG. 9) accommodated in an enclosure 70 of a hemispheric shell structure. The enclosure 70 is attached to a ceiling 72 of a store, for instance. Also, each memory 14a (see FIG. 9) connected to each image pickup unit 12a is provided in the enclosure 70.

An attachment hole is formed at the position corresponding to a pole (lowest point) of the enclosure 70 and the image pickup unit 12a (image pickup module 26) is provided in the attachment hole so that the imaging lense 34 is directed toward the outside.

Also, for the surface of the enclosure 70, the attachment holes (not shown) are formed at predetermined intervals so that each of their centers is positioned in an edge portion of the same plane. In this embodiment, attachment holes whose positions in a direction vertical to a center line V passing through the pole are different from each other and whose centers are positioned in edge portions of three planes α, β, γ orthogonal to the center line V are formed at predetermined pitches. The image pickup units 12a are attached to the attachment holes. As a result, the image pickup modules 26 are provided along the surface of the hemispheric enclosure 70.

In this embodiment, for instance, four image pickup units 12a (image pickup modules 26) having the same focal length are provided in the edge portion of the plane a closest to the pole, out of the three planes α, β, and γ. Also, for instance, eight image pickup units 12a (image pickup modules 26) having the same focal length are provided in the edge portion of the plane β which is farther from the pole than the plane a. Further, for instance, six image pickup units 12a (image pickup modules 26) having the same focal length are provided in the edge portion of the plane γ that is the farthest from the pole. In this manner, the photographing system 10c is provided with in total 19 image pickup units 12a (image pickup modules 26).

In this embodiment, the more the distance from the pole is increased, the longer the focal length of the image pickup unit 12a (image pickup module 26) used is. For instance, the photographing magnification of the photographing unit 12a is set such that the photographing magnification of the image pickup modules having a longer focal length is higher than the photographing magnification of the image pickup modules having a shorter focal length.

In the present invention, the temporary storage section 14 is not necessary to provide in the enclosure 70. For instance, the temporary storage section 14 may be provided outside the enclosure 70 and connection may be established in a wireless or wired manner.

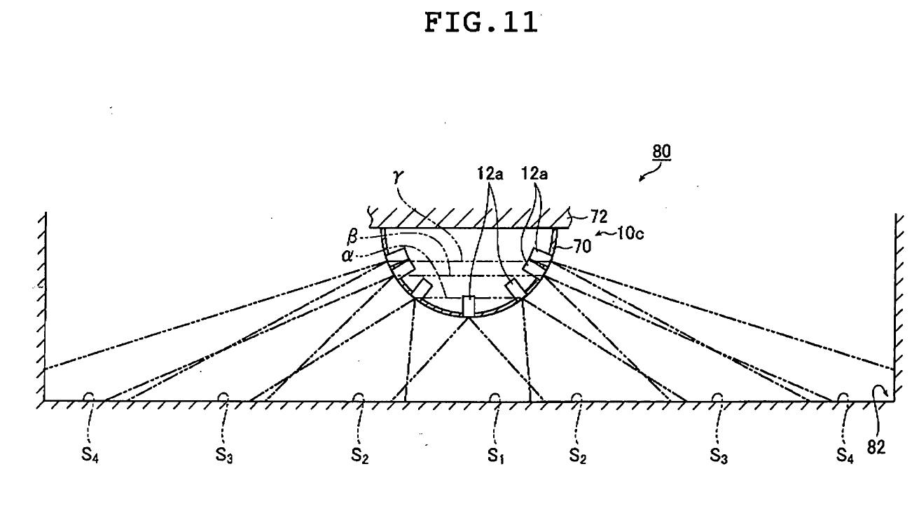

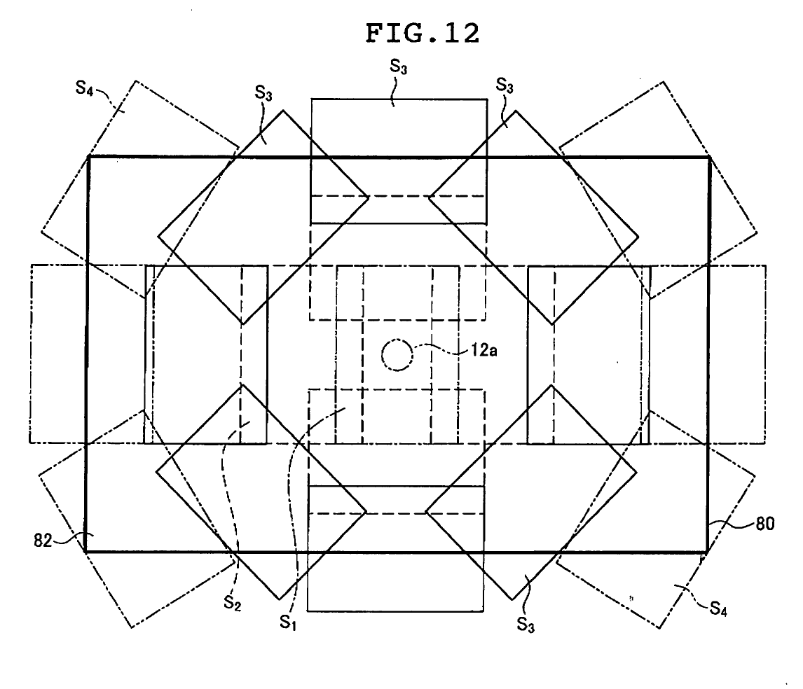

FIG. 11 is a schematic partial cross-sectional view showing a state in which the photographing system in this embodiment is installed at a store. FIG. 12 is a schematic plan view showing a photographing range of each image pickup unit of the photographing system shown in FIG. 11.

As shown in FIG. 11, the photographing system 10c is attached to a ceiling 72 of a store 80 and makes a down shot of a floor 82 (inside) of the store 80.

In the photographing system 10c, the image pickup unit 12a provided in the pole (lowest portion) has a photographing range S₁. Also, each image pickup unit 12a provided for the plane a has a photographing range S₂. Further, each image pickup unit 12a provided for the plane β has a photographing range S₃. Still further, each image pickup unit 12a provided for the plane γ has a photographing range S₄.

In the photographing system 10c in this embodiment, as shown in FIGS. 11 and 12, the areas of the photographing ranges S₁ to S₄ on the floor 82 of the store 80 are the same and the image pickup units 12a (see FIG. 2) are arranged so that the adjacent photographing ranges S₁ to S₄ overlap each other and no dead angle is generated on the floor 82 in the store 80.

In this embodiment, as shown in FIG. 12, the store 80 whose floor 82 has a rectangular shape is monitored. The floor 82 has a rectangular shape, so each region photographed in the photographing range S₄ is smaller than each region photographed in the photographing range S_{3.} Therefore, in this embodiment, the number of the image pickup modules having the longest focal length is set smaller than the number of the image pickup modules that photograph the photographing range S₃.

In the photographing system 10c of the invention, the focal length of each image pickup module 26 is changed depending on the position at which the module 26 is attached to the enclosure 70 and the imaging lens of the image pickup module 26 is selected so that the same size is obtained for the same photographing target regardless of which image pickup module 26 is used for photographing.

In this embodiment, for instance, image pickup modules whose focal lengths are changed in four steps, are used. In a direction from the photographing range S₁ to the photographing range S₄, the focal length of the image pickup module used is increased. Also, in the direction from the photographing range S₁ to the photographing range S₄, the photographing range is widened, so it is required to increase the number of the image pickup modules arranged. Further, in order to reduce unnecessary overlapping of the photographing regions, the image pickup modules having longer focal lengths should be arranged higher than the image pickup modules having shorter focal lengths.

The image pickup modules provided for the same plane have the same focal length, so the modules should be arranged at an equal distance from the center line V, that is, in a circular or arc manner in the edge portion of the plane.

FIG. 13 is a schematic diagram showing an arrangement state of the image pickup units of the photographing system according to the fourth embodiment of the present invention. In FIG. 13, each image pickup unit 12a is indicated with a black circle (●).

As shown in FIG. 13, in this embodiment, the image pickup units are arranged at predetermined pitches d_{α}, d_{β}, and d_{γ} in the edge portions of the respective planes α, β, and γ. The image pickup units 12 are capable of achieving the effect of the present invention by making the pitches d_{α}, d_{β}, and d_{γ} identical to each other regardless of the focal lengths and uniformly arranging the same number of image pickup units 12a for each plane. However, in this case, the overlapping of the photographing regions is increased and the number of the image pickup modules is also increased, and hence the capacity of the recording means must be increased. As a result, the load placed on the control section is increased. Therefore, the number of the image pickup units 12a that pick up images of the far photographing range S₄ is increased and the pitch d_{γ} is reduced. That is, the image pickup modules are arranged densely. On the other hand, the number of the image pickup units 12a that pick up images of the near photographing range S₂ is reduced and the pitch d_{γ} is increased. That is, the image pickup modules are arranged sparsely. By appropriately setting the numbers of the image pickup modules in accordance with the photographing ranges in this manner, it becomes possible to minimize the number of the image pickup modules while preventing a dead angle from being generated.

In this embodiment, by providing multiple image pickup modules having different focal lengths, it becomes possible to pick up images of a photographing target in the same size at all times in a photographing region and record the images. Also, image distortion will not occur unlike the case of a conventional camera using a fish-eye lens. As a result, it becomes possible to record a photographing target discriminably while preventing distortion.

Also, in the photographing region, even when photographing is performed with the image pickup modules, it is possible to track a target and further photograph the target in the same size at all times, so it becomes possible to perform tracking of a specific target with ease. As a result, when the photographing system according to the present invention is applied to crime prevention, it becomes possible to identify a suspicious person with ease.

Further, an entrance hall may be set as the photographing range of the photographing system, an image of each member of a family may be registered, and the alarm section may be activated when a person other than the family members gets near the entrance. Still further, the photographing system may be, installed at houses adjacent to each other, thereby performing mutual suspicious person monitoring.

The photographing system 10c in this embodiment is capable of photographing in all directions covering 360°, although the present invention is not limited to this. It is possible to set the photographable angle as appropriate in accordance with the photographing target region. For instance, when the photographing range is 180°, the photographing system 10c has a shape in which the enclosure 70 has been cut along a vertical plane containing the center line V.

Further, the image pickup units (image pickup modules) are arranged in a circular manner, although the arrangement of the image pickup modules is not limited to this. For instance, when an escalator, an elevator hall, or a rectangular passage is photographed, even when the image pickup modules are arranged in a linear manner, the same effect as in this embodiment can be achieved. As described above, in the present invention, it is possible to determine the pitch and length of the image pickup units arranged in an arc or linear manner for each focal length in accordance with the photographing target region.

Also, in this embodiment, the attachment holes are formed in the enclosure 70 and the image pickup modules are attached to the attachment holes, although the present invention is not limited to this. For instance, the image pickup modules may be attached to a frame having a ring-shaped member instead of being directly attached to the enclosure 70.

Also, the shape of the enclosure 70 is not specifically limited. When the image pickup modules are not directly attached to the enclosure 70, the enclosure 70 may have a shape corresponding to its installation place.

Also, in this embodiment, when it is desired to track a specific player, by inputting features or the like of the player in advance, it becomes possible to perform the tracking processing with ease even when the image pickup modules photograph the player. As a result, it becomes possible to provide videos corresponding to viewer preferences with ease. In addition, it also becomes possible to edit recorded images, record the edited images on a storage medium such as a CD, a DVD, or a video tape, and provide the storage medium.

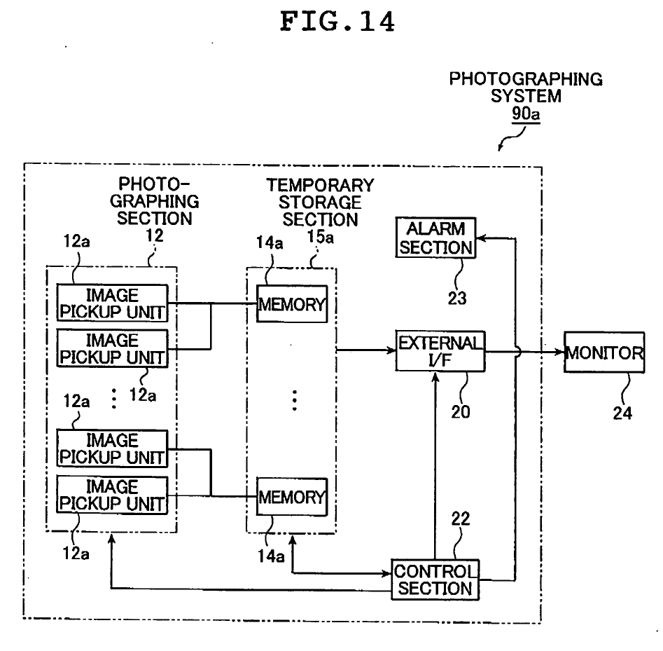

Further, the photographing system 10c in this embodiment may have a construction in which one memory 14a is provided for the image pickup units 12a. For instance, a construction of a photographing system 90a shown in FIG. 14 may be used in which one memory 14a of a temporary storage section 15a is provided for two image pickup units 12a. In this case, by allocating a memory port or the like to each image pickup unit 12a, it becomes possible to identify each image pickup unit 12a. Also, when connection is established in a wireless manner, a different frequency is allocated to each image pickup unit 12a or a transmission signal with identification information is outputted from each image pickup unit 12a, for instance. With this construction, it becomes possible to identify each image pickup unit 12a.

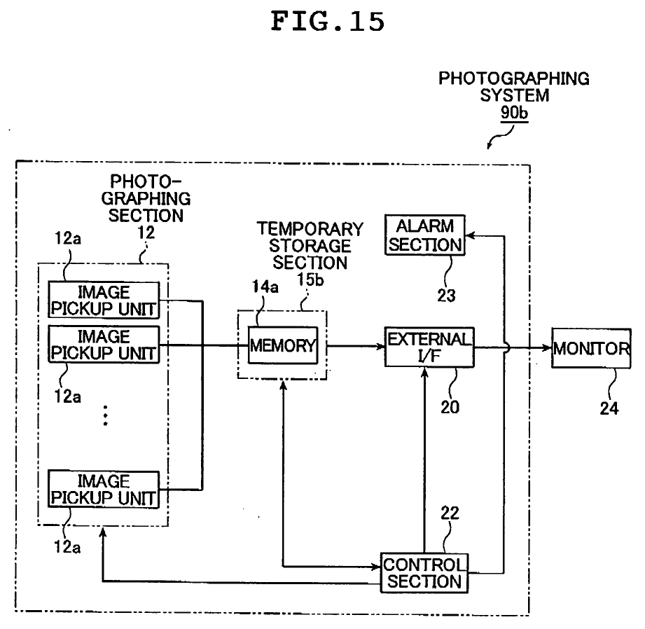

Further, in the photographing system 10c in this embodiment, for instance, a construction of a photographing system 90b shown in FIG. 15 may be used in which one memory 14a is provided for all image pickup units 12a. That is, a construction may be used in which one memory 14a is provided in a temporary storage section 15b. In this case, by allocating a port of the memory 14a or the like to each image pickup unit 12a, it becomes possible to identify each image pickup unit 12a. Also, when connection is established in a wireless manner, a different frequency is allocated to each image pickup unit 12a or a transmission signal with identification information is outputted * from each image pickup unit 12a, for instance. With this construction, it becomes possible to identify each image pickup unit 12a.

The present invention basically has the construction described above. The photographing system and the photographing method according to the present invention have been described in detail above, although the present invention is not limited to the embodiments described above and it is of course possible to make various modifications and changes without departing from the gist of the present invention.

1. A photographing system for photographing a predetermined photographing spacetime, comprising:
image pickup modules having different focal lengths, each picking up an image in said predetermined photographing spacetime,
wherein said image pickup modules are set such that a photographing magnification of said image pickup modules having a longer focal length is higher than a photographing magnification of said pickup modules having a shorter focal length.

2. The photographing system according to claim 1,
wherein each of said image pickup modules having said different focal lengths has an in-focus range where a target of the same size is clearly picked up when said target of the same size is photographed at an arbitrary point in time in said photographing spacetime,
wherein said image pickup modules having said different focal lengths are arranged such that respective in-focus ranges of said image pickup modules are continuous or partially overlap each other in a photographing direction.

3. The photographing system according to claim 1,
wherein said image pickup modules include groups of plural image pickup modules which are provided for each focal length and a group of plural image pickup modules having the same focal length photograph a photographing range of said predetermined photographing spacetime, which two-dimensionally extends in a direction orthogonal to said photographing direction.

4. The photographing system according to claim 1, further comprising:
a display unit that displays an image photographed by each of said image pickup modules or a composite image of photographed images.

5. The photographing system according to claim 1,
wherein among said image pickup modules, said image pickup modules having long focal lengths are arranged densely as compared with said image pickup modules having short focal lengths.

6. The photographing system according to claim 1,
wherein photographing magnifications of said image pickup modules are set such that, when a target of the same size is photographed at an arbitrary point in time in said photographing spacetime, said target images having the same size are obtained.

7. The photographing system according to claim 1,
wherein a photographing distance is set for each of focal lengths of said image pickup modules.

8. The photographing system according to claim 1,
wherein a photographing range is formed by a group of image pickup modules for each focal length and respective groups of image pickup modules are arranged such that centers of photographing ranges formed by said respective groups of image pickup modules having the same focal lengths are positioned on the same line.

9. The photographing system according to claim 8,
wherein a first photographing range by a first group of image pickup modules having a short focal length is smaller than a second photographing range by a second group of image pickup modules having a long focal length.

10. The photographing system according to claim 8,
wherein a first photographing range by a first group of image pickup modules having a short focal length is larger than a second photographing range by a second group of image pickup modules having a long focal length.

11. The photographing system according to claim 1,
wherein photographing timings of said image pickup modules are synchronized with each other.

12. The photographing system according to claim 1,
wherein each of said image pickup modules includes a photoelectric conversion element that obtains image data of a photographing target by photoelectrically converting a target image of said photographing target.

13. A photographing method, comprising:
using image pickup modules being set such that a photographing magnification of said image pickup modules having a longer focal length is higher than a photographing magnification of said pickup modules having a shorter focal length; and
photographing said predetermined photographing spacetime.
